(19) United States
(12) Patent Application Publication
(10) Pub. No.: US 2024/0352246 A1
(43) Pub. Date: Oct. 24, 2024

(54) NON-HALOGENATED, SELF-EXTINGUISHING RESIN COMPOSITIONS AND METHODS FOR PRODUCING SAME

(71) Applicant: Trinseo Europe GmbH, Horgen (CH)

(72) Inventors: Mark C. Gatman, Erlanger, KY (US); Roger Neil Caldwell, Erlanger, KY (US)

(21) Appl. No.: 18/687,348

(22) PCT Filed: Aug. 31, 2022
(86) PCT No.: PCT/US2022/075716

§ 371 Date: Feb. 28, 2024

Related U.S. Application Data
(60) Provisional application No. 63/239,175, filed on Aug. 31, 2021.

(51) Int. Cl. C08L 33/12; C08J 5/18; C08K 3/22; C08K 3/38; C08L 67/00

(52) U.S. Cl. CPC C08L 33/12; C08J 5/18; C08K 3/22; C08K 3/38; C08L 67/00; C08J 2333/12; C08K 2003/2227; C08K 2003/387; C08L 2201/02

(57) ABSTRACT

Resin compositions include a) about 35 wt % to about 90 wt % of an primary acrylic component or about 10 wt % to about 90 wt % of a polyester component; b) about 0 wt % to about 10 wt % of a comonomer; and c) about 10 wt % to about 15 wt % of an organo-phosphorus/nitrogen flame resistant composition. Methods include i.) preparing an acrylic resin composition including: a) about 35 wt % to about 90 wt % of an primary acrylic component or about 10 wt % to about 90 wt % of a polyester component; b) about 0-10 wt % of a comonomer; and c) about 10-15 wt % of an organo-phosphorus/nitrogen flame resistant composition; and ii) processing the acrylic resin by continuous casting to form a sheet or surface.

### BACKGROUND

Polymer materials have wide applicability in commercial and residential applications, including use as components of construction and furnishing materials. In addition to mechanical strength, polymer materials may be formulated to produce sheets and surfaces having high transparency and luster. However, when exposed to heat and friction, polymer materials can create fire hazards as a source of fuel, and may also emit toxic smoke and speed flame spread by dripping. Given the potential hazards, regulatory bodies may require polymer materials (particularly those used commercial marine and aviation) to be flame resistant, self-extinguishing, and/or conform to various limits on fire spread, volatiles released, and smoke generation.

To meet regulatory and safety requirements, polymer materials are often formulated with flame resistant compositions that can minimize fire hazards in the presence of possible ignition sources. But the tradeoff is often exchanging increased flame resistance at the expense of other desirable properties, such as mechanical performance, appearance, transparency, and the like. The diminished performance and appearance can be a significant obstacle, particularly when the polymer materials are utilized in high visibility applications and decorative finishes.

### SUMMARY OF THE DISCLOSURE

In an aspect, resin compositions include a) about 35 wt % to about 90 wt % of an primary acrylic component or about 10 wt % to about 90 wt % of a polyester component: b) about 0 wt % to about 10 wt % of a comonomer: and c) about 10 wt % to about 15 wt % of an organo-phosphorus/nitrogen flame resistant composition.

In another aspect, methods include i.) preparing an acrylic resin composition including: a) about 35 wt % to about 90 wt % of an primary acrylic component or about 10 wt % to about 90 wt % of a polyester component: b) about 0-10 wt % of a comonomer: and c) about 10-15 wt % of an organo-phosphorus/nitrogen flame resistant composition: and ii) processing the acrylic resin by continuous casting to form a sheet or surface.

### DETAILED DESCRIPTION

The present disclosure relates to compositions and methods of producing a non-halogenated, self-extinguishing acrylic compositions and articles. Resin compositions disclosed herein may include the use of non-halogenated flame resistant compositions to prepare sheets, surfaces, and other articles having high transparency and thermoformability that are self-extinguishing and meet regulatory requirements for flame spread and smoke density generation. In another aspect, the present disclosure is directed to improved methods of processing acrylic resin compositions into sheets that may include “post-cure” treatments in which formed sheets and surfaces are heated at elevated temperatures after forming to improve self-extinguishing properties.

Resin compositions disclosed herein may include acrylic resin compositions, polyester resin compositions, and blends thereof. Acrylic resin compositions disclosed herein may include an acrylic component derived from one or more (meth)acrylate monomers. As used herein, use of the parenthetical “(meth)” in conjunction with acrylate is a shorthand indication that either monomer form (e.g., acrylate or a methacrylate) of the ester or acid may be used in the presently disclosed compositions. Suitable monomers that may be used to prepare acrylic resin compositions disclosed herein include (meth)acrylic acid or C1 to C9 ester of (meth)acrylate, including methyl (meth)acrylate, ethyl (meth)acrylate, butyl (meth)acrylate, iso-butyl (meth)acrylate, t-butyl (meth)acrylate, hexyl (meth)acrylate. 2-ethylhexyl (meth)acrylate, octyl (meth)acrylate, phenyl (meth)acrylate, benzyl (meth)acrylate, cyclohexyl (meth)acrylate, and the like.

The acrylic component may be present as an acrylic pre-polymerized syrup that optionally includes one or more comonomers or copolymers. The acrylic pre-polymerized syrup can be included at a percent by weight (wt %) of about 35 wt % to about 95 wt % of the acrylic resin composition. In some embodiments, the pre-polymerized syrup can include a percent by weight of solids (wt %) of about 5 w1% to about 40 wt %. The acrylic pre-polymerized syrup can include polymers and oligomers having a weight average molecular weight in a range between about 10 kg/mol to about 450 kg/mol.

Resin compositions may also include a primary polyester base component. Polyester resins may include any suitable polyester polymer, prepolymer, or monomer mixture of polyols and polyacids. Suitable polyester types include polyethylene terephthalate, poly butylene terephthalate, polycarbonate, polybutyrate, polyglycolic acid, polylactic acid, poly-2-hydroxy butyrate, polycaprolactaone, and the like, and copolymers and blends thereof. The polyester component can also include one or more comonomers, copolymers, oligomers, or pre-polymers at a percent by weight (wt %) of the resin composition in a range of about 5 wt % to about 90 wt %, about 5 wt % to about 95 wt %, or about 10 wt % to about 95 wt %.

The acrylic or polyester component can also include one or more comonomers, copolymers, oligomers, or pre-polymers at a percent by weight (wt %) of the resin composition in a range of about 0 wt % to about 10 wt %, about 0 wt % to about 20 wt %, or about 0 wt % to about 25 wt %. Suitable comonomers (and polymers, oligomers, or pre-polymers formed therefrom) can be selected from any one or more of the (meth)acrylate monomers disclosed above. In some embodiments, the acrylic component may include a comonomer selected from a C1 to C6 ester of (meth)acrylate, such as methyl (meth)acrylate, ethyl (meth)acrylate, propyl (meth)acrylate, butyl (meth)acrylate and the like. For acrylic resin compositions incorporating copolymers or additional pre-polymers, the copolymers or additional pre-polymers can have a weight average molecular weight in a range between about 10 kg/mol to about 450 kg/mol.

Resin compositions may be formulated with a one or more non-halogenated flame resistant compositions minimize the flammability and/or extent of fire damage incurred to a composition or article exposed to heat, friction and other ignition sources. Acrylic sheets and articles combined with flame resistant compositions disclosed herein may have similar appearance, clarity, and mechanical performance to comparative untreated acrylics.

Flame resistant compositions disclosed herein may include organo-phosphorus/nitrogen (P/N) flame resistant compositions, which may be a combination of organo-phosphorus and nitrogen compounds: compounds prepared from reacting an organo-phosphorus and nitrogen compounds: monomeric, oligomeric, or (co)polymeric organo-phosphorus and/or nitrogen compounds that are combined with the acrylic resin composition prior to or during polymerization: and mixtures thereof. The nature of the individual organo-phosphorus and nitrogen compounds is not regarded as critical, and various species may be combined to produce a flame resistant composition disclosed herein.

Organo-phosphorus compounds may include phosphate esters such as triphenyl phosphate, tricresyl phosphate, cresyldiphenyl phosphate, 2-ethylhexyldiphenyl phosphate, tri-n-butyl phosphate, trixylenyl phosphate, resorcinol(bis)diphenyl phosphate and bisphenol A bis(diphenyl phosphate), 9,10-dihydro-9-oxa-10-phosphaphenanthrene-10-oxide, and the like.

In some embodiments, organo-phosphorus compounds may include carbon-carbon unsaturation to facilitate incorporation within the acrylic composition during polymerization. Polymerizable organo-phosphorus compounds include dimethyl phosphate-(meth)acryloyloxymethyl, diethyl phosphate-(meth)acryloyloxymethyl, diphenyl phosphate-(meth)acryloyloxymethyl, dimethyl phosphate-2-(meth)acryloyloxyethyl, diethyl phosphate-2-(meth)acryloyloxyethyl, diphenyl phosphate-2-(meth)acryloyloxyethyl, dimethyl phosphate-3-(meth)acryloyloxypropyl, diethyl phosphate-3-(meth)acryloyloxypropyl and diphenyl phosphate-3-(meth)acryloyloxypropy, and the like.

Nitrogen-based compounds that may be incorporated into flame resistant compositions include ammonium compounds and triazine skeleton-containing compounds, such as melamine, melamine resin, polycyanurate, benzothiazole derivatives such as 2-aminobenzothiazole, and the like. Nitrogen-based compounds may also include polymerizable compounds such as tris(acryloxyethyl) isocyanurate and triallyl isocyanurate.

Flame resistant compositions prepared from reacting an organo-phosphorus and nitrogen compounds may include ammonium polyphosphate, ammonium melamine-modified polyphosphate, coated ammonium polyphosphate, nitrogen containing oligomers and ammonium polyphosphates such as polyallylammonium pyrophosphate, melamine pyrophosphate, phosphazenes, polyphosphonamide derivatives, and the like.

Flame resistant compositions disclosed herein may be admixed with an acrylic resin composition at a percent by weight (wt %) of about 5 wt % to about 20 wt %, 5 wt % to about 15 wt %, or about 10 wt % to about 15 wt %. Addition of the flame resistant composition may be done at any stage prior to polymerization and/or crosslinking of the acrylic resin composition. Flame resistant compositions may include a mass ratio of organophosphorus compound: nitrogen compound of at least about 4:1 to about 1:4, at least about 3:1 to about 1:3, or at least about 2:1 to about 1:2.

In some embodiments and separate from the flame resistant compositions, other flame resistant additives may be incorporated into an acrylic resin composition such as aluminum trihydrate, borates, and the like. Additional flame resistant additives may be admixed with an acrylic resin composition at a percent by weight (wt %) of about 5 wt % to about 20 wt %, 5 wt % to about 15 wt %, or about 10 wt % to about 15 wt %.

Acrylic resin compositions can also include a number of functional additives to initiate and control various properties during polymerization and thermoforming reactions including initiators, chain transfer agents, wetting/dispersing agents, anti-flocculating agents, pigments, release agents, air release agents, and the like.

Chain transfer agents disclosed herein include compounds that regulate the length of the polymer chains and can include octyl mercaptan, iso-dodecyl mercaptan, thiurams, dithiocarbarumates, dipentene dimercaptan, 2-mercaptoethanol, allyl mercapto-acetates, ethylene glycol dimercapto-acetate, trimethylolethane trithioglycolate, pentaery thritol tetrathioglycolate, and the like.

During various processing methods to form acrylic sheets and articles, one or more initiators may be combined with an acrylic resin composition to begin a chain polymerization. Initiators disclosed herein include any suitable free radical initiator such as t-butyl peroxypivalate, t-butyl peroxyneodeconate, t-amyl peroxy-2-ethyl-hexanoate, and the like.

Acrylic resin compositions can also include crosslinking agents having two or more vinyl groups capable of forming intra-and inter-molecular crosslinks within the acrylic matrix during processing and/or thermoforming. Suitable crosslinking agents include ethylene glycol dimethacrylate, propylene dimethylacrylate, polyethylene glycol dimethacrylates such as PEG200 and PEG600 dimethacrylate, triallyl isocyanurate, triallyl cyanurate, divinyl benzene, diallyl phthalate, 1,3-butanediolmethacrylate, 1,4-butane ethylene glycol dimethacrylate, neopentyl glycol dimethacrylate, trimethylol propane trimethacrylate, pentaerythritol tetramethacrylate, allylmethacrylate, hydroxyethylmethacrylate, hydroxypropylmethacrylate, and the like. In some embodiments, acrylic compositions can include one or more crosslinking agents at a percent by weight (wt %) within a range of 0.05 wt % to 1.5 wt %, 0.05 wt % to 1.5 wt %, or 0.05 wt % to 1.5 wt %.

Acrylic resin compositions disclosed herein may be processed into an acrylic sheet by any suitable method, including continuous casting processes, such as that described in U.S. Patent Pub. 2021/0102057; U.S. Pat. No. 3,371,383; or U.S. Pat. No. 3,376,371; which are incorporated herein by reference. Other processing methods that can be applied to produce acrylic articles include thermoforming, extrusion molding, coextrusion molding, extrusion coating, injection molding, injection blow molding, inject stretch blow molding, thermoforming, cast film extrusion, blown film extrusion, foaming, extrusion blow-molding, injection stretched blow-molding, rotomolding, pultrusion, calendering, additive manufacturing, lamination, and the like.

Processed acrylic resin compositions may be treated by a post-curing processes in which formed articles are subjected to elevated temperatures (˜200° F. or above) for a period of time to drive off residual monomer and other volatiles and drive crosslinking and other reactions to completion. Post-cure processes may improve thermal stability and produce surfaces and articles having reduced relative time to self-extinguishing. Post-cure processes may include treatment at temperatures greater than about 200° F., greater than about 220° F., or greater than about 260° F. for a period of time that may range from about 5 minutes to about 30 minutes, about 5 minutes to about 15 minutes, or about 5 minutes to about 10 minutes.

Resin compositions disclosed herein and articles formed therefrom may meet the specification for Class A or B flame resistant materials according to ASTM E84-21. In some embodiments, acrylic resin compositions and articles formed therefrom may have a smoke development index (SDI) according to ASTM E84-21 of about 350 or less, about 300 or less, or about 150 or less. In some embodiments, acrylic resin compositions and articles formed therefrom may have a flame spread index according to ASTM E84-21 of about 150 or less, about 100 or less, about 50 or less, or about 25 or less.

Resin compositions disclosed herein and articles formed therefrom may meet the specification for flame resistant materials, including a flammability class rating for horizontal burn (HB) and vertical flame (V) melt tests according to UL-94 (2021). Resin compositions disclosed herein may be regarded as flame resistant and satisfy the requirements for UL-94 (2021) ratings of HB and V0. The general testing criteria are introduced below.

For the UL-94 HB test, flame is applied by burner for 30 seconds and the travel of the flame along a test specimen is recorded and graded. The HB rating may vary according to sample size as indicated in Table 1.

TABLE 1
UL-94 HB rating details

| | | | Flammability |
|---|---|---|---|
| Sample Criteria | Burning rate | | rating |
| Test specimen thickness 3-13 mm | ≤40 | mm/min | HB |
| Test specimen thickness <3 mm | ≤75 | mm/min | HB |
| Flame is extinguished before first mark | =0 | mm/min | HB |

For the UL-94 V test, flame is applied by burner two times for 10 seconds each application. At the second application of flame, the travel of the flame along a test specimen is recorded and graded. The V rating may vary according to sample size as indicated in Table 2.

TABLE 2
UL-94 V rating details

| Test criteria | V0 | V1 | V2 |
|---|---|---|---|
| Burning time of each individual test | ≤10 | ≤30 | ≤30 |
| specimen (s) | | | |
| (after first and second flame applications) | | | |
| Total burning time (s) | ≤50 | ≤250 | ≤250 |
| (10 flame applications) | | | |
| Burning and afterglow times after second | ≤30 | ≤60 | ≤60 |
| flame application (s) | | | |
| Dripping of burning specimens | no | no | yes |
| (ignition of cotton batting) | | | |
| Combustion up to holding clamp | no | no | no |
| (specimens completely burned) | | | |

Articles formed from resin compositions disclosed herein may have a heat deflection temperature (HDT) according to ASTM D648-18 at 264 psi of about 150° F. or greater, about 170° F. or greater, or about 180° F. or greater.

Resin compositions and articles formed therefrom may exhibit transparency values that are approximate to acrylic resin compositions formulated without a flame resistant composition disclosed herein. In some embodiments, acrylic resin compositions and articles formed therefrom may have a transmittance according to ASTM D1003-21 of less than about 5% haze, about 10% haze, or about 15% haze.

Resin compositions and articles prepared therefrom disclosed herein may exhibit enhanced blistering temperatures over comparative acrylic formulations. Blister temperatures are determined by visual inspection for the formation of blisters (surface imperfections) developed on a 4″×4″ sample after 40 minutes in an oven at 340° F. and rated as pass or fail. In some cases, acrylic compositions may exhibit blister temperatures of greater than 340° F., greater than 360° F., or greater than 400° F. Blister formation may also be modified by the inclusion of a (meth)acrylate ester such as a C4 to C8 acrylate, at a monomer percent in the range of about 1% to about 20%, about 1% to about 10%, or about 5% to about 10%.

Acrylic compositions disclosed herein may exhibit a melt flow index (MFI) according to ASTM 1238-98 at 230° C./3.8 kg of about 0.5 g/10 min or less, about 0.3 g/10 min or less, about 0.1 g/10 min or less, or about 0 (undetectable), and may also range between any two of those values.

For crosslinked solid surfaces produced after processing acrylic resin compositions, the molecular weight of the polymer matrix and degree of crosslinking is characterized according to the thermoformability parameter (Q value) that is used to describe the swelling ratio of the cross-linked acrylic. The Q value is described according to Eq. 1:

$$Q value = ( Wt + We / Ds ) + 0.1 Wo / Do \qquad ( 1 )$$

where the Q value is the swelling ratio, Wt is the weight of the swollen polymer at equilibrium, We is the weight of the extracted materials, Ds is the density of the solvent (methylene chloride=1.336), Wo is the weight of the original sample, and Do is the density of the polymer (acrylic=1.2). In general, a decreasing Q value indicates increased crosslink density. Acrylic compositions disclosed herein can form articles having a Q value ranging from 5 to 25 following thermoforming in some embodiments.

In some embodiments, resin compositions disclosed herein may have a weight average molecular weight prior to crosslinking in a range of about 250 kg/mol to about 600 kg/mol.

Formulation guidelines for the production of resin compositions disclosed herein are provided in Table 3.

TABLE 3
Representative Formulation Guidelines for Acrylic Resin Compositions

| Class | Example Component | Amount | |
|---|---|---|---|
| Acrylic Pre-Polymer | Acrylic pre-polymerized syrup at 20% | 35-95 | wt % |
| | solid | | |
| Polyester | — | 10-90 | wt % |
| Copolymer or comonomer | MMA—methyl methacrylate | 0-10 | wt % |
| Organo-phosphorus/nitrogen | — | 5-20 | wt % |
| flame resistant composition | | | |
| Wetting/dispersing agent | BYK1142 | 0.0-1 | wt % |
| Coupling agent | 3-methacryloxypropyl trimethoxy | 0.0-1.0 | wt % |
| | silane | | |
| Anti-flocculating agent | Triisooctyl phosphate | 0.1-0.8 | wt % |
| Pigment | — | 0.5-4.0 | wt % |
| Chain transfer agent | N-dodecyl mercaptan | 0.2-2.0 | wt % |
| Release agent | Zelec UN-Phosphate ester | 0.05-0.1 | wt % |
| Crosslinking agent | Ethylene glycol dimethacrylate | 0.1-1.0 | wt % |
| Initiator 1* | t-butyl peroxypivalate | 0.01-0.4 | wt % |
| Initiator 2* | t-butyl peroxyneodecanoate | 0.0-0.4 | wt % |
| Initiator 3* | t-amyl peroxy-2-ethyl-hexanoate | 0.01-0.2 | wt % |
| | Silica (fumed and/or precipitated) | 0.1-5.0 | wt % |
| Air Release Agent | BYK 555 | 0.0-1.0 | wt % |

Resin compositions and articles formed therefrom may be used anywhere a flame source, such as an electrical failure, friction, or spark, could result in a catastrophe when using standard cast acrylic sheet. Suitable applications may include use of flame resistant acrylic articles in commercial and residential environments including vehicles such as railways, airlines, and ships, aerospace applications, structural environments such as residences, retail stores and restaurants, hospitals and hotels, and the like. Fire resistant articles prepared from resin compositions disclosed herein may satisfy regulatory requirements, including building codes dictated by the International Code Council (ICC) and the International Building Code (IBC).

### EXAMPLES

### Example 1—Data and Results of Project Dragon Testing for Linear Burn Rate of Plastics

In the following examples, resin compositions were processed for form sheets by containing casting methods and subjected to UL-94 HB burn testing to assess flame resistance.

### Comparative Sample 1

Comparative samples were prepared from PMMA resins (crosslinked and non-crosslinked) and formulated without a flame resistant additive. The comparative PMMA samples were 3 mm thick and maintained a consistent burn during HB testing beyond the 25 mm mark that continued beyond the 100 mm mark for crosslinked and non-crosslinked samples. The calculated linear burn rate was 28.5 mm/minute, which was within expectation of literature values. Ignited samples produced intense black smoke during the test, and generated substantial polymer drippings that ignited and remained burning. UL-94 V (vertical) testing was not performed, but literature values indicate that the burn rates would be faster than the horizontal test burn rate.

### Sample 1—Acrylic Sheet Containing Flame Resistant Composition

Acrylic resin compositions were prepared with an organo-phosphorus/nitrogen (P/N) flame resistant composition in accordance with the present disclosure and processed for form sheets by containing casting. Sample 1 sheet was 3 mm thick and subjected to HB testing. During testing, Sample 1 self-extinguished immediately upon removal of the flame source on both the first and second burns. The calculated linear burn rate was zero. No black smoke was witnessed, and no drippings were observed.

Sample 1 was also tested according the UL-94 V (vertical) testing methodology. During testing the sheet immediately self-extinguished, resulting in a V0 rating.

### Sample 2—Polycarbonate Sheet Containing Flame Resistant Composition

Polycarbonate resin compositions were prepared with an organo-phosphorus/nitrogen (P/N) flame resistant composition in accordance with the present disclosure and processed for form sheets by containing casting. A 3 mm polycarbonate sheet self-extinguished immediately but resulted in excessive black smoke and non-burning dripping.

### Sample 3—Polyester Sheet Containing Flame Resistant Composition

Polyester resin compositions were prepared with an organo-phosphorus/nitrogen (P/N) flame resistant composition in accordance with the present disclosure and processed for form sheets by containing casting. A 12 mm polyester sheet self-extinguished immediately with no smoke and no drippings.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed, including the lower limit and upper limit. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed:

1. A resin composition, comprising:
a) about 35 wt % to about 90 wt % of an primary acrylic component or about 10 wt % to about 90 wt % of a polyester component;
b) about 0 wt % to about 10 wt % of a comonomer; and
c) about 10 wt % to about 15 wt % of an organo-phosphorus/nitrogen flame resistant composition.

2. The resin composition of claim 1, wherein the organo-phosphorus/nitrogen flame resistant composition comprises a polymerizable species selected from one or more of organo-phosphorus compound, nitrogen-based compound, or organo-phosphorus/nitrogen compound.

3. The resin composition of claim 1, comprising a primary acrylic component, wherein the acrylic component comprises a pre-polymerized syrup.

4. The resin composition of claim 3, wherein the acrylic pre-polymerized syrup has a percent by weight of solids (wt %) ranging from 5 wt % to 40 wt %.

5. The resin composition of claim 1, further comprising about 0.1 wt % to about 1.0 wt % of a crosslinking agent.

6. The resin composition of claim 1, wherein the comonomer is a C4 to C8 (meth)acrylate ester.

7. The resin composition of claim 1, wherein the resin composition further comprises a flame resistant additive selected from aluminum trihydrate or borate.

8. The resin composition of claim 7, wherein the flame resistant additive is an aluminum trihydrate present at a percent by weight (wt %) of about 5 wt % to about 15 wt %.

9. A sheet or slab comprising the resin composition of claim 1.

10. The sheet or slab of claim 9, wherein the resin composition forms an article having a Q value ranging from 5 to 25.

11. The sheet or slab of claim 9, wherein the article exhibits a passing rating according to UL-94 for V0.

12. The sheet or slab of claim 9, wherein the article exhibits a passing rating according to UL-94 for HB.

13. A method comprising:
i.) preparing an acrylic resin composition comprising:
a) about 35 wt % to about 90 wt % of an primary acrylic component or about 10 wt % to about 90 wt % of a polyester component;
b) about 0-10 wt % of a comonomer; and
c) about 10-15 wt % of an organo-phosphorus/nitrogen flame resistant composition; and
ii) processing the acrylic resin by continuous casting to form a sheet or surface.

14. The method of claim 13, further comprising treating the sheet or surface to a post-curing process at a temperature above 200° F. for about 5 minutes to about 30 minutes.

15. The method of claim 13, comprising a primary acrylic component, wherein the acrylic component comprises a pre-polymerized syrup.

16. The method of claim 15, wherein the acrylic pre-polymerized syrup has a percent by weight of solids (wt %) ranging from 5 wt % to 40 wt %.

17. The method of claim 13, wherein the sheet has a Q value ranging from 5 to 25.

18. The method of claim 13, wherein the composition further comprises a flame resistant additive selected from aluminum trihydrate or borate.

19. The resin composition of claim 13, wherein the flame resistant additive is an aluminum trihydrate present at a percent by weight (wt %) of about 5 wt % to about 15 wt %.

20. The method of claim 13, wherein the sheet or surface exhibits a passing rating according to UL-94 for V0 and HB.
